(19) United States
(12) Patent Application Publication
(10) Pub. No.: US 2017/0144448 A1
(43) Pub. Date: May 25, 2017

(54) INK QUALITY SENSOR AND A CONDITION MONITORING SYSTEM FOR AN INKJET PRINTER

(71) Applicant: Videojet Technologies, Inc., Wood Dale, IL (US)

(72) Inventor: Robert SMITH, Thrapston (GB)

(21) Appl. No.: 15/352,955

(22) Filed: Nov. 16, 2016

Related U.S. Application Data
(60) Provisional application No. 62/259,949, filed on Nov. 25, 2015.

(51) Int. Cl. B41J 2/175

(52) U.S. Cl. CPC B41J 2/17566; B41J 2002/17579

(57) ABSTRACT

An ink quality system for an inkjet printer includes an ink reservoir including a volume of ink. A first sensor is disposed in the ink reservoir. At least a portion of the first sensor is in contact with the volume of ink. A second sensor is disposed in the ink reservoir. At least a portion of the second sensor is in contact with the volume of ink. Electronic circuitry is in electrical communication with the first sensor and the second sensor and configured to measure a quality of the ink by measuring the resistance between the first sensor and the second sensor.

### BACKGROUND

The present invention relates to inkjet printing and more particularly to an ink quality sensor for an inkjet printer such as a continuous inkjet printer. It also relates to a continuous inkjet printer with a condition monitoring system including a plurality of sensors for various printer components.

In inkjet printing systems, the print is made up of individual droplets of ink generated at a nozzle and propelled towards a substrate. There are two principal systems: drop on demand where ink droplets for printing are generated as and when required; and continuous inkjet printing in which droplets are continuously produced and only selected ones are directed towards the substrate, the others being recirculated to an ink supply.

Continuous inkjet printers supply pressurized ink to a print head drop generator where a continuous stream of ink emanating from a nozzle is broken up into individual regular drops by, for example, an oscillating piezoelectric element. The drops are directed past a charge electrode where they are selectively and separately given a predetermined charge before passing through a transverse electric field provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. The charged drops bypass the gutter and hit the substrate at a position determined by the charge on the drop and the position of the substrate relative to the print head. Typically the substrate is moved relative to the print head in one direction and the drops are deflected in a direction generally perpendicular thereto, although the deflection plates may be oriented at an inclination to the perpendicular to compensate for the speed of the substrate (the movement of the substrate relative to the print head between drops arriving means that a line of drops would otherwise not quite extend perpendicularly to the direction of movement of the substrate).

In continuous inkjet printing a character is printed from a matrix comprising a regular array of potential drop positions. Each matrix comprises a plurality of columns (strokes), each being defined by a line comprising a plurality of potential drop positions (e.g. seven) determined by the charge applied to the drops. Thus, each usable drop is charged according to its intended position in the stroke. If a particular drop is not to be used, then the drop is not charged and it is captured at the gutter for recirculation. This cycle repeats for all strokes in a matrix and then starts again for the next character matrix.

Ink is delivered under pressure to the print head by an ink supply system that is generally housed within a sealed compartment of a cabinet that includes a separate compartment for control circuitry and a user interface panel. The system includes a main pump that draws the ink from a reservoir or tank via a filter and delivers it under pressure to the print head. As ink is consumed the reservoir is refilled as necessary from a replaceable ink cartridge that is releasably connected to the reservoir by a supply conduit. The ink is fed from the reservoir via a flexible delivery conduit to the print head. The unused ink drops captured by the gutter are recirculated to the reservoir via a return conduit by a pump. The flow of ink in each of the conduits is generally controlled by solenoid valves and/or other like components.

As the ink circulates through the system, there is a tendency for it to thicken as a result of solvent evaporation, particularly in relation to the recirculated ink that has been exposed to air in its passage between the nozzle and the gutter. To compensate for this, “make-up” solvent is added to the ink as required from a replaceable ink cartridge so as to maintain the ink viscosity within desired limits. This solvent may also be used for flushing components of the print head, such as the nozzle and the gutter, in a cleaning cycle.

The ink and solvent cartridges are filled with a predetermined quantity of fluid and generally releasably connected to the reservoir of the ink supply system so that the reservoir can be intermittently topped-up by drawing ink and/or solvent from the cartridges as required. To ensure the cartridges are brought into correct registration with supply conduits, the cartridges are typically connected to the ink supply system via a docking station comprising a cartridge holder. When the cartridges are correctly docked fluid communication with an outlet port of the cartridge is ensured.

It is important from the manufacturer's perspective that the inkjet printer consumes only ink (or solvent) of the correct type and quality. If a cartridge containing the wrong ink is used, the printing quality can be compromised and, in extreme cases, printer failure may be caused. It is therefore known, in some inkjet printers, to provide the cartridge with an externally machine readable label (e.g. a bar code) carrying information regarding the fluid contained within the cartridge. The label is swiped past a reader associated with the control system of the printer before the cartridge is installed and only when the control system of the printer has read the information on the label and verified that the ink is suitable for operation with the printer does it allow ink or solvent to be drawn from the cartridge.

### BRIEF SUMMARY

The present disclosure provides an ink quality system for an inkjet printer.

In one aspect, an ink quality system for an inkjet printer includes an ink reservoir including a volume of ink. A first sensor is disposed in the ink reservoir. At least a portion of the first sensor is in contact with the volume of ink. A second sensor is disposed in the ink reservoir. At least a portion of the second sensor is in contact with the volume of ink. Electronic circuitry is in electrical communication with the first sensor and the second sensor and configured to measure a quality of the ink by measuring the resistance between the first sensor and the second sensor.

In another aspect, a method of measuring quality of ink in an inkjet printer, includes providing a volume of ink in the inkjet printer, providing a first sensor and a second sensor in electrical contact with the ink, and providing an electrical signal to the first sensor. The output of the second sensor is processed to measure resistance of the ink to determine a resistivity of the ink.

In another aspect, the invention a condition monitoring system that includes multiple sensors for monitoring different operating parameters associated with the operation of a print head and the operation of an ink supply system. A continuous inkjet printer includes a print head and an ink supply system for supplying ink to a print head. The ink supply system includes an ink reservoir, a system pump for conveying ink from the ink reservoir to the print head, an ink source, and a solvent source.

In one aspect the inkjet printer or condition monitoring system comprises a plurality of print head sensors associated with the print head to detect and monitor a plurality of different operating parameters associated with the operation of the print head. Each print head sensor is configured to generate electrical signals indicative of a monitored print head operating parameter detected by a respective print head sensor. In addition, the printer or system includes a plurality of ink supply sensors associated with the ink supply system and configured to detect and monitor a plurality of different operating parameters associated with the operation of the ink supply system. Each ink supply sensor is configured to generate electrical signals indicative of a monitored operating parameter associated with a respective ink supply system sensor.

In another aspect a print head control board is provided in electrical signal communication with each print head sensor, and the print head control board is configured to generate data representative of the respective monitored operating parameter of the print head. An ink module control board is provided in electrical signal communication with each ink supply sensor, and the ink module control board is configured to generate data representative of each respective monitored operating parameter of the ink supply system. A main control board is provided in electrical signal communication with the print head control board and the ink module control board, wherein the main control board includes stored programmable instructions to generate outputs in response to data received from the print head control board and the ink supply control module and each output is associated with a monitored parameter of the print head or a monitored parameter of the ink supply system.

In an aspect, the print head sensors may include for example an accelerometer, a temperature sensor, an ink-build up sensor (or gutter detect sensor), a phase sensor and an EHT sensor. In addition, other sensors relative to the print head and the associated monitored parameters may be included as described below in more detail.

In an aspect, the ink supply sensors may include sensors that detect and/or monitor ambient temperature and/or ambient humidity, a gas sensor, ink pressure sensors, ink and solvent temperature sensor, ink level sensors and solvent sensors, and ink quality sensors. In addition, other sensors relative to the ink supply system and the associated monitored parameters may be included as described below in more detail.

In another aspect, the outputs generated by the main control board may include, for example, warnings or alarms when monitored parameters have fallen outside set thresholds, information regarding the remaining useful live of a print head or ink supply component, current operating temperatures such as viscosity, remaining volume, ink density and other outputs described in more detail below.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a schematic illustration showing components of an embodiment of an inkjet printer.

FIG. 2 is a schematic showing the inkjet printer of FIG. 1.

FIG. 3 is an electrical schematic showing an embodiment of an ink quality sensor.

FIG. 4A is an exploded view of an embodiment of a viscometer.

FIG. 4B is a partial cut-away view showing the viscometer of FIG. 4A.

FIG. 5 is an exploded view of an embodiment of a service module.

FIG. 6A is a top perspective view a printed circuit board of the service module of FIG. 5.

FIG. 6B is a bottom perspective view of the printed circuit board of FIG. 6B.

FIG. 7 is a schematic drawing of continuous inkjet printer with a condition monitoring system including a plurality of sensors.

### DETAILED DESCRIPTION

The invention is described with reference to the drawings in which like elements are referred to by like numerals. The relationship and functioning of the various elements of this invention are better understood by the following detailed description. However, the embodiments of this invention as described below are by way of example only, and the invention is not limited to the embodiments illustrated in the drawings.

The present disclosure relates to a system for measuring ink quality in an inkjet printer. The system measures the resistivity of the ink to determine if it is within an acceptable range and takes a predetermined action if it falls outside an acceptable range. The present disclosure also relates to a continuous inkjet printer with a plurality of sensors for various printer components.

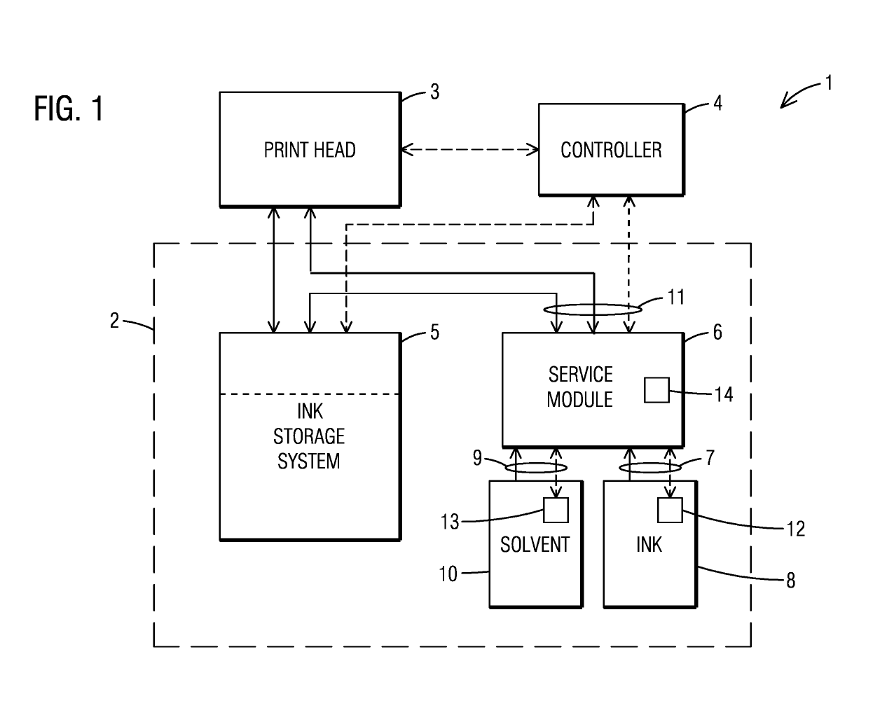

The specifics of the ink quality system will be discussed below but first it is helpful to provide an overview of an embodiment of an inkjet printer of which the ink quality system may be a part. FIG. 1 schematically illustrates an inkjet printer 1. Inkjet printer 1 includes an ink supply system 2, a print head 3 and a controller 4. The ink supply system 2 includes an ink storage system 5 and a service module 6 according to an embodiment of the present invention. In FIG. 1, fluid flow through the inkjet printer is illustrated schematically by solid arrows and control signals are illustrated schematically by dashed arrows. The service module 6 is configured for releasable engagement with inkjet printer 1 so that the module can be easily removed from the inkjet printer 1 for servicing or replacement. The service module 6 is therefore a removable module for an inkjet printer.

The service module 6 includes two cartridge connections for releasable engagement with a fluid cartridge. In particular, the service module 6 includes an ink cartridge connection 7 for releasable engagement with an ink cartridge 8 and a solvent cartridge connection 9 for releasable engagement with a solvent cartridge 10. The service module 6 further includes a printer connection 11 for releasable engagement with an inkjet printer. In use, the service module 6 forms part of inkjet printer 1 and it will be appreciated that in this context in the expression “for releasable engagement with an inkjet printer” the term “inkjet printer” is intended to mean those parts of the inkjet printer excluding the service module 6.

The printer connection 11 includes a plurality of fluid ports, each fluid port arranged to connect to a fluid pathway within the inkjet printer 1 to allow fluid to flow between the service module 6 and other parts of the inkjet printer 1, such as the ink storage system 5 and the print head 3. The printer connection 11 further includes an electrical connector arranged to engage with a corresponding connector on the inkjet printer 1.

Each of the ink and solvent cartridge connections 7, 9 includes a fluid connector for engaging an outlet of respective ink and solvent cartridges 8, 10 so as to allow fluid to flow from the cartridges 8, 10 into the service module 6. From the service module 6, ink and solvent can flow to the ink storage system 5 via the printer connection 11. In operation, ink from the ink cartridge 8 and solvent from the solvent cartridge 10 can be mixed within the ink storage system 5 so as to generate printing ink of a desired viscosity which is suitable for use in printing. This ink is supplied to the print head 3 and unused ink is returned from the print head 3 to the ink storage system 5. The service module 6 is also operable to provide a flow of solvent to the print head 3 via printer connection 11 for cleaning purposes.

The inkjet printer 1 is controlled by controller 4. Controller 4 receives signals from various sensors within the inkjet printer 1 and is operable to provide appropriate control signals to the ink supply system 2 and the print head 3 to control the flow of ink and solvent through the inkjet printer 1. The controller 4 may be any suitable device known in the art, and typically includes at least a processor and memory.

The ink cartridge 8 may be provided with an electronic data storage device 12 storing data relating to contained ink (e.g. type and quantity of ink). Similarly, the solvent cartridge 10 may be provided with an electronic data storage device 13 storing data relating to contained solvent (e.g. type and quantity of solvent). The service module 6 includes an electronic data storage device 14. Electronic data storage device 14 may store identification data (e.g. an identification code). Electronic data storage device 14 may also store other types of data, such as identification data relating to the type of ink and/or solvent that the service module 6 can be used with (or has previously been used with), a model number of the service module 6 or inkjet printer 1, a serial number, a manufacture date, an expiration date, a date first used in service, number of hours the service module 6 has been used in the inkjet printer 1, service life, and the like. Information stored on any one of the electronic data storage devices 12, 13, 14 may be stored in encrypted form. This may prevent any tampering of the data. The electronic data storage device 14 may include security data so that only suitable or recognized service modules 6 can be used with the inkjet printer 1. The electronic data storage device 14 may also include a writable data portion. The inkjet printer 1 may write to the electronic data storage device 14 to indicate that the service module 6 has reached the end of its service life, so that the service module 6 can no longer be used in the inkjet printer 1 or any other printer.

The controller 4 is arranged to communicate with the electronic data storage devices 12, 13. This communication with the electronic data storage devices 12, 13 of cartridges 8, 10 is via the service module 6. Each of the ink and solvent cartridge connections 7, 9 includes an electrical contact arranged to contact a corresponding contact on the engaged ink or solvent cartridge 8, 10. Said corresponding contact on the cartridges 8, 10 allows information to be read from and/or written to data storage devices 12, 13 respectively via the printer connection 11 of the service module 6.

For example, when the ink supply system 2 is first used, data from the electronic data storage device 12 and/or the electronic data storage device 13 is read to ascertain a type of ink and/or solvent being used. Subsequently, when a new ink cartridge or solvent cartridge is used within the printer 1, a check may be made by the controller 4 of data stored on respective electronic data storage devices 12, 13 of the ink cartridge 8 and the solvent cartridge 10 to ensure compatibility. In this way, when the ink supply system 2 is used with a particular type of ink, the controller 4 ensures that the printer 1 is operable (i.e. ensures that ink is allowed to flow from the ink cartridge 8 and/or that solvent is allowed to flow from the solvent cartridge 10) only if data associated with the ink cartridge 8 and/or solvent cartridge 10 as stored on the electronic data storage devices 12, 13 indicates compatibility.

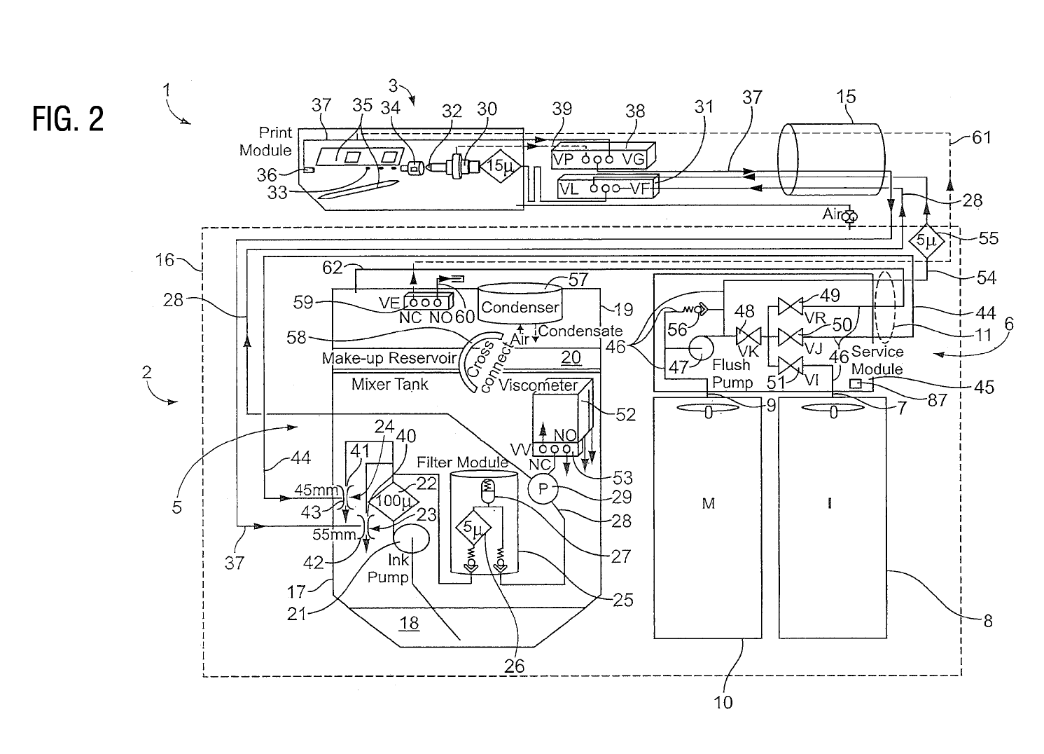

The inkjet printer 1, and particularly the ink supply system 2 is now described in further detail, with reference to FIG. 2. FIG. 2 schematically shows elements of the inkjet printer 1 of FIG. 1 in greater detail and, for clarity, the controller 4 and associated signals have been omitted.

In operation, ink is delivered under pressure from ink supply system 2 to print head 3 and back via flexible tubes which are bundled together with other fluid tubes and electrical wires (not shown) into what is referred to in the art as an “umbilical” conduit 15. The ink supply system 2 is located in a cabinet 16 which is typically table mounted and the print head 3 is disposed outside of the cabinet 16.

The ink storage system 5 includes a mixer tank 17 for storage of a reservoir of ink 18 and a solvent tank 19 for storage of a reservoir of solvent 20. The mixer tank has a generally tapered lower portion within which the reservoir of ink 18 is disposed. In an embodiment, sensors for the ink quality system are disposed in the mixer tank 17, but other locations are possible as will be further described.

In operation, ink is drawn from the reservoir of ink 18 in mixer tank 17 by a system pump 21. The mixer tank 17 is topped up as necessary with ink and make-up solvent from replaceable ink and solvent cartridges 8, 10. Ink and solvent are transferred from the ink and solvent cartridges 8, 10 to the mixer tank 17 via the service module 6 as will be described further below.

It will be understood from the description that follows that the ink supply system 2 and the print head 3 include a number of flow control valves which are of the same general type: a dual coil solenoid-operated two-way flow control valve. The operation of each of the valves is governed by the controller 4.

Ink drawn from the mixer tank 17 is filtered first by a first (relatively coarse) filter 22 downstream of the system pump 21 and then is delivered selectively under pressure to two venturi pumps 23, 24 and a filter module 25. Filter module 25 includes a second, finer ink filter 26 and a fluid damper 27. Fluid damper 27 is of conventional configuration and removes pressure pulsations caused by the operation of the system pump 21. Ink is supplied through a feed line 28 to the print head 3 via a pressure transducer 29.

At the print head 3 the ink from the feed line 28 is supplied to a drop generator 30 via a first flow control valve 31. The drop generator 30 includes a nozzle 32 from which the pressurized ink is discharged and a piezoelectric oscillator (not shown) which creates pressure perturbations in the ink flow at a predetermined frequency and amplitude so as break up the ink stream into drops 33 of a regular size and spacing. The break up point is downstream of the nozzle 32 and generally coincides with a charge electrode 34 where a predetermined charge is applied to each drop 33. This charge determines the degree of deflection of the drop 33 as it passes a pair of deflection plates 35 between which a substantially constant electric field is maintained. Uncharged drops pass substantially undeflected to a gutter 36 from where they are recycled to the ink supply system 2 through return line 37 via a second flow control valve 38. Charged drops are projected towards a substrate (not shown) that moves past the print head 3. The position at which each drop 33 impinges on the substrate is determined by the amount of deflection of the drop and the speed of movement of the substrate.

To ensure effective operation of the drop generator 30 the temperature of the ink entering the print head 3 may be maintained at a desired level by a heater (not shown) before it passes to the first control valve 31. In instances where the printer is started up from rest it is desirable to allow ink to bleed through the nozzle 32 without being projected toward the gutter 36 or substrate. In such instances ink flows from the first control valve 31 to the nozzle 32 and then returns to the second control valve 38 via a bleed line 39, where it joins return line 37. The passage of the ink into the return line 37, whether it is the bleed flow or recycled unused ink captured by the gutter 36, is controlled by the second flow control valve 38. The returning ink is drawn back to the mixer tank 17 by venturi pump 23.

Venturi pumps 23, 24 are of known configuration and make use of the Bernoulli Principle whereby fluid flowing through a restriction in a conduit increases to a high velocity jet at the restriction and creates a low pressure area. If a side port is provided at the restriction this low pressure can be used to draw in and entrain a second fluid in a conduit connected to the side port. In this instance, the pressurized ink flows through a pair of conduits 40, 41 and back to the reservoir 18 in the mixer tank 17. Each conduit 40, 41 is provided with a side port 42, 43 at the venturi restriction. The increase in flow velocity of the ink creates a suction pressure at the side port 42, 43 and this serves to draw returning ink and/or solvent through return line 37 and a supply line 44 respectively.

As ink flows through the system and comes into contact with air in the mixer tank 17 and at the print head 3, a portion of its solvent content tends to evaporate. The ink supply system 2 is therefore operable to supply make-up solvent as required so as to maintain the viscosity of the ink within a predefined range suitable for use.

The service module 6 includes a body 45 defining a plurality of fluid conduits (shown schematically in FIG. 2 as lines 46). The service module 6 further includes a flush pump 47 and four valves 48, 49, 50, 51 which are arranged to selectively link two or more of the plurality of fluid conduits 46 so as to form one or more fluid pathways through the body 45. The flush pump 47 and the valves 48, 49, 50, 51 are controlled by the controller 4 by sending one or more control signals via the printer connection 11. Using appropriate control signals, the service module 6 can be disposed in a plurality of different configurations to allow ink or solvent to flow through the inkjet printer 1 in a plurality of different modes, as now described. In the following, it should be assumed that each of the four valves 48, 49, 50, 51 is closed unless stated otherwise.

In operation, ink from the ink cartridge 8 and solvent from the solvent cartridge 10 can be added to the mixer tank 17 as required so as to generate printing ink of a desired viscosity which is suitable for printing. This addition of ink and/or solvent to the mixer tank 17 uses venturi pump 24.

Mixer tank 17 is provided with a level sensor (not shown) that is operable to determine a level of ink in the mixer tank 17 and output a signal indicative thereof to controller 4. Ink is consumed during printing and therefore during normal operation the level of ink in the mixer tank 17 will fall over time. When the level of ink in the mixer tank falls below a lower threshold the controller 4 is operable to control the ink supply system 2 so as to add more ink to the mixer tank 17. Using suitable control signals, ink is drawn from the mixer tank 17 by system pump 21 and delivered under pressure to venturi pump 24 to create suction pressure at the side port 43. To add ink to the mixer tank 17, valves 50, 51 in the service module 6 are opened. Ink is drawn from ink cartridge 8 along supply line 44 under suction pressure from venturi pump 24. The ink discharges into the mixer tank 17, increasing the level. When the level of ink in the mixer tank 17 reaches an upper threshold the controller 4 is operable to stop the supply of ink to mixer tank 17. To achieve this, flow to venturi pump 24 is stopped and valves 50, 51 are closed.

Following such a process of topping up the level of ink in mixer tank 17, the controller 4 sends a signal to data storage device 12 on ink cartridge 8 indicative of the quantity of ink that has been transferred from the cartridge 8 to the mixer tank 17. A quantity of ink remaining in the ink cartridge 8 may be stored on the data storage device 12 and may be updated in response to the signal from the controller 4.

As explained above, as ink flows through the system and comes into contact with air in the mixer tank 17 and that the print head 3, a portion of its solvent content tends to evaporate. Periodically, the viscosity of the ink within the mixer tank 17 (or a quantity indicative thereof) is determined using a viscometer 52 disposed in mixer tank 17.

The viscometer 52 is periodically supplied with ink under pressure from system pump 21 via filter module 25. Flow of ink into the viscometer is controlled by control valve 53. Using control valve 53, a predetermined volume of ink is supplied to a chamber within viscometer 52 and then supply of ink to the viscometer is stopped. Ink then drains out of the chamber under gravity. The rate at which the ink drains out of the chamber is dependent on the viscosity of the ink and is monitored using a plurality of electrodes disposed at different levels within the chamber. Signals from the plurality of electrodes are received by controller 4, which is operable to determine whether or not the viscosity of ink within the mixer tank 17 is within a desired operating range, defined by lower and upper threshold values. In a preferred embodiment, sensors for the ink quality system are disposed in viscometer 52, as will be described below, but other locations are possible.

If the viscosity is above the upper threshold value then solvent is added to the mixer tank 17 from solvent reservoir 20 in solvent tank 19 as now described. Ink is drawn from the mixer tank 17 and delivered under pressure to venturi pump 24 to create suction pressure at the side port 43. To add solvent, valves 49, 50 in the service module 6 are opened. Under suction pressure from the venturi pump 24, solvent is drawn from solvent reservoir 20 along line 62 to the service module 6 and back along supply line 44 to the mixer tank 17. The solvent discharges into the mixer tank 17, reducing the viscosity of the ink in reservoir 18.

The controller 4 may determine a quantity of solvent to add to the mixer tank 17 based on the determined viscosity of the ink. When a desired quantity of solvent has been added to the mixer tank 17, flow to the venturi pump 24 may be stopped and the valves 49, 50 are closed.

Once solvent has been added to the mixer tank 17, the viscometer 52 may be used again to determine the viscosity of ink. There may be a time delay between adding the solvent and re-checking the viscosity of the ink so as to allow the solvent to mix with ink. If upon re-checking the viscosity of the ink in mixer tank 17 the viscosity is still above the upper threshold value, then more solvent may be added to the mixer tank 17 from solvent reservoir 20 in solvent tank 19. This process may be repeated until a desired viscosity of ink in mixer tank 17 is reached.

Solvent tank 19 is provided with a level sensor (not shown) that is operable to determine a level of solvent in the solvent tank 19 and output a signal indicative thereof to controller 4. Solvent is consumed during operation of the printer 1 as it is added to the mixer tank 17 to adjust the viscosity of the ink in reservoir 18. Therefore, the level of solvent in the solvent reservoir 20 in solvent tank 19 falls over time.

When the level of solvent in the solvent tank 19 falls below a lower threshold, the controller 4 is operable to control the ink supply system 2 so as to add more solvent to the solvent tank 19. Using suitable control signals, valves 48, 49 in the service module 6 are opened. Solvent is drawn from solvent cartridge 10 by electric flush pump 47 in the service module 6 and is supplied through line 62 to the solvent reservoir 20. The solvent discharges into the solvent reservoir 20, increasing the level.

When the level of solvent in the solvent tank 19 reaches an upper threshold the controller 4 is operable to stop the supply of solvent to solvent tank 19. To achieve this, flow to flush pump 47 is stopped and valves 48, 49 are closed.

Following such a process of topping up the level of solvent in solvent tank 19, the controller 4 sends a signal to data storage device 13 on solvent cartridge 10 indicative of the quantity of solvent that has been transferred from the cartridge 10 to the solvent tank 19. A quantity of solvent remaining in the solvent cartridge 10 may be stored on the data storage device 13 and may be updated in response to the signal from the controller 4.

Make-up solvent, provided from the solvent cartridge 10, is also used to flush the print head 3 at appropriate times to keep it clear of blockages, as now described. Ink is drawn from the mixer tank 17 and delivered under pressure to venturi pump 23 to create a suction pressure at the side port 42. Solvent is drawn from solvent cartridge 10 by electric flush pump 47 in the service module 6 and is supplied through a flush line 54 to the print head 3 via filter 55. Flow of solvent from the service module 6 to the print head 3 is controlled by first control valve 31.

A pressure relief valve 56 is connected across the inlet and outlet of the flush pump 47 and acts to relieve excess pressure to the suction side of the flush pump 56. For example, pressure relieve valve 56 may be arranged to maintain a desired pressure downstream of the flush pump 47, for example 2.5 bar.

The solvent flows through the first control valve 31 to the nozzle 32. After passing through the nozzle 32 and into the gutter 36 the solvent (along with dissolved ink from the print head 3) is drawn into the return 32 under suction pressure from the venturi pump 23. The solvent and ink discharge into the mixer tank 17.

As explained above, flow of ink and solvent into mixer tank 17 is achieved using venturi pump 24, which requires a minimum quantity of fluid in mixer tank 17. If there is insufficient fluid in the mixer tank 17 for operation of the venturi pump 24 (e.g. before a first use of the ink supply system 2), the flush pump 47 in service module 6 can be used to prime the mixer tank 17 by adding fluid to it.

To prime the mixer tank 17, an ink cartridge is engaged with the solvent cartridge connection 9. To add ink to the mixer tank 17, valves 48, 50 in the service module 6 are opened. Ink is drawn from an ink cartridge (in the solvent cartridge connection 9) by electric flush pump 47 in the service module 6 and is supplied through supply line 44 to the mixer tank 17 via side port 42. Once a sufficient quantity of ink has been added to the mixer tank 17, flush pump 47 is stopped and valves 48, 50 are closed.

In use, the atmosphere in the mixer tank 17 and the solvent tank 19 can become saturated with solvent. A condenser unit 57 is provided in an upper portion of the solvent tank 19. Condenser unit 57 may, for example, include a Peltier-type condenser.

A ventilation tube 58 is provided between the mixer tank 17 and the solvent tank 19 to allow air to flow therebetween. The ventilation tube 58 is arranged such that it links a space above the reservoir of ink 18 to a space above the reservoir of solvent 20. Solvent-laden vapor from the mixer tank 17 enters the solvent tank 19 via ventilation tube 58. The air from the mixer tank 17 is warmer than the air in the solvent tank (due to the action of the system pump 21), and therefore it rises to the top of the solvent tank via ventilation tube 58, where it enters the condenser unit 57.

Solvent condenses as the air contacts an active element within the condenser unit 57 and is cooled. The condensate (solvent) drains into the solvent reservoir 20. The dried air (from which the solvent has been removed) enters the common port of a three-way control valve 59. The flow of air through the system can be controlled using control valve 59, as now described.

The dried air from the condenser unit 57 may flow through exit line 60, via which it is vented to the air space inside the printer cabinet 16. This air flow path may be a default configuration for control valve 59.

Alternatively, the dried air from the condenser unit 57 may flow through line 61 which passes through the umbilical 15 to the print head 3. Line 61 terminates in the print head 3 at return line 37, near the gutter 36. Vacuum pressure draws the vented air along the return line 37 towards the second control valve 38 (along with any ink entering the gutter 36). Normal operation of venturi pump 23 draws the unused ink drops and vented air along the return line 37, through the umbilical 15 and back to side port 42. The unused ink and vented air are both discharged into the mixer tank 17.

When control valve 59 is used to direct the dried air from the condenser unit 57 through line 61, a ‘closed’ hydraulic loop is created. Any solvent vapor which is not recovered by the condenser unit 57 passes back to the mixer tank 17 via lines 61, 32 and loss of solvent from the inkjet printer 1 is therefore minimized. The system recirculates the same air continuously, which prevents (or at least minimizes) the influx of ambient air, which would otherwise enter via the gutter 36 (e.g. if the control valve 59 is venting the dried air from the condenser unit 57 to the air space inside the printer cabinet 16 via exit line 60). This preclusion of ambient air entering the system helps to prevent oxygen ingestion via the gutter 36, which promotes improved ink performance over the long term by reducing the probability of ink oxidation.

Turning now to further details of the ink quality sensor, the printer system includes a resistivity sensor to measure the resistivity of the ink to determine its quality. It is known that as ink ages or degrades, the resistivity goes up (or put another way, the conductivity goes down). This may be caused by, for example, oxidation or other chemical reaction of the binders or salts that provide at least in part the resistivity of the ink. The conductivity often goes down due to oxidation of the organic chromium dyes used as conductive agents. It has been found that when resistivity goes past 2500 Ohms·cm (or equivalently, when conductivity goes below 400 micro Siemens/cm) print quality will start to suffer depending on the type of raster used for the type of resin in the ink. The system may provide that when the resistivity is above 2000 ohms·cm it provides a warning to an operator that the ink is getting less conductive.

High resistivity can negatively affect print quality and gutter sensor detection. It can depend on resin type and resin molecular weight to some degree. Inks with higher molecular weight resins tend to break off with more difficulty and/or long break-off tails will be more sensitive, everything else being equal. The type of rasters being printed by the printer also may have a significant impact on print quality. For example, with a given Videojet commercial ink, a resistivity up to 3000 ohms·cm is still acceptable using a single line and slow speed printing raster. For a high speed tri-line raster, negative print impact is seen at about 3000 ohms·cm. For another Videojet ink which tends to break-off more difficult, a print quality impact was seen at 2500 Ohms·cm with high speed raster and tri-line tall fonts. When the resistivity was in the 3000-4000 ohms·cm range it was also seen that the gutter sensor not consistently detecting the presence of the jet in the gutter.

It is desired to keep the ink in a certain range of resistivity in order to provide the proper electrical properties of the ink for droplet generation and deflection. If the resistivity is outside predetermined parameters, the system will add fresh ink to the reservoir to bring it within the desired range. This may be an iterative process so that after fresh ink is added, the resistivity is again measured and more ink is added until the resistivity falls below the desired value.

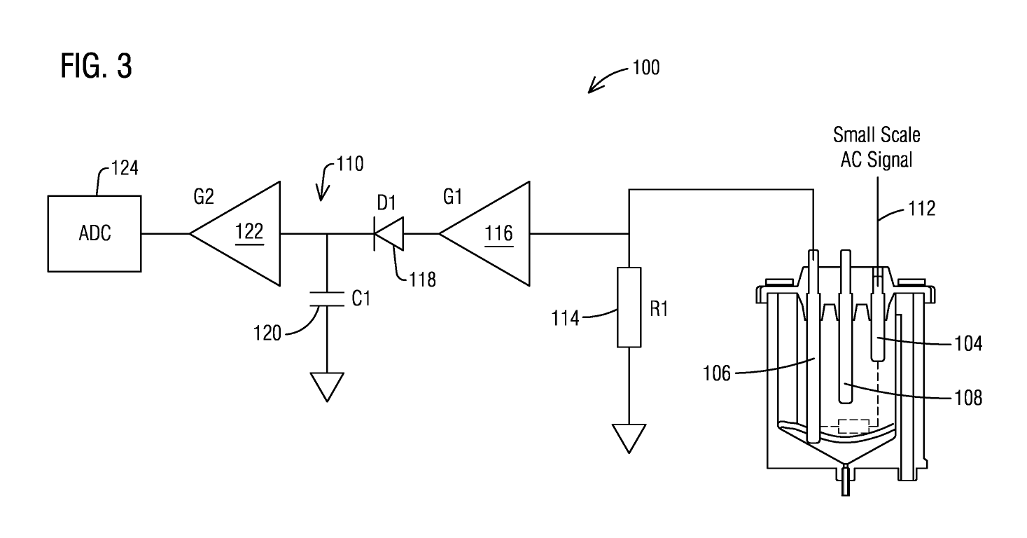

An embodiment of such an ink quality sensor system is shown in FIG. 3. The system 100 includes an ink reservoir 102 holding a volume of ink. At least two sensors 104, 106 are provided in the ink reservoir. There may be other sensors as well, such as sensor 108. At least a portion of the first sensor 104 and second sensor 106 are in contact with the volume of ink. Electronic circuitry 110 is in electrical communication with the first sensor and the second sensor and configured to measure a quality of the ink by measuring the resistance between the first sensor and the second sensor. The resistivity of the ink can easily be determined, as is known in the art, from the measured resistance and the configuration of the sensors and the distance between them.

In the embodiment shown in FIG. 3, the system includes three sensors 104, 106, 108 disposed in the reservoir 102 which are also used for determining the ink level in the reservoir. To measure the resistance of the ink, at predetermined intervals, a signal to sensor 108 is suspended and isolated, since sensor 108 is not used to measure the resistance. The fluid level in the reservoir is increased until the ink reaches a known and controlled level. A signal on sensor 104 causes a small current 112 to flow through Resistor(ink)+Resistor(R1) 114; as the resistance of the ink increases, the current decreases. The current 112 may be alternating current. The voltage drop across R1 is proportional to this current and is amplified, rectified and smoothed by amplifier 116, rectifier 118, and capacitor 120. The smoothed signal is amplified by second amplifier 122 before passing to an analogue to digital converter 124, wherein the digital signal is read by the system.

As previously described, the printer includes a viscometer 52. The viscometer 52 includes two or more probes that are used to measure the ink level in the viscometer chamber. The viscometer chamber is in fluid communication with the mixing tank 17 and ink is provided between the mixing tank and the viscometer, as shown in FIG. 2. The ink quality sensor system could also be in the mixing tank 17 of the system.

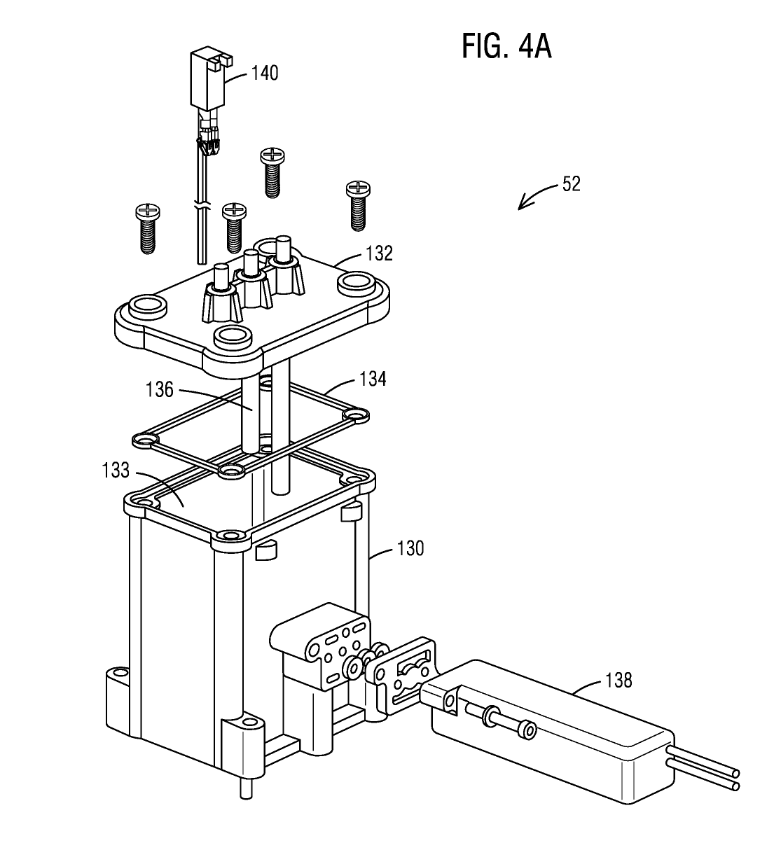

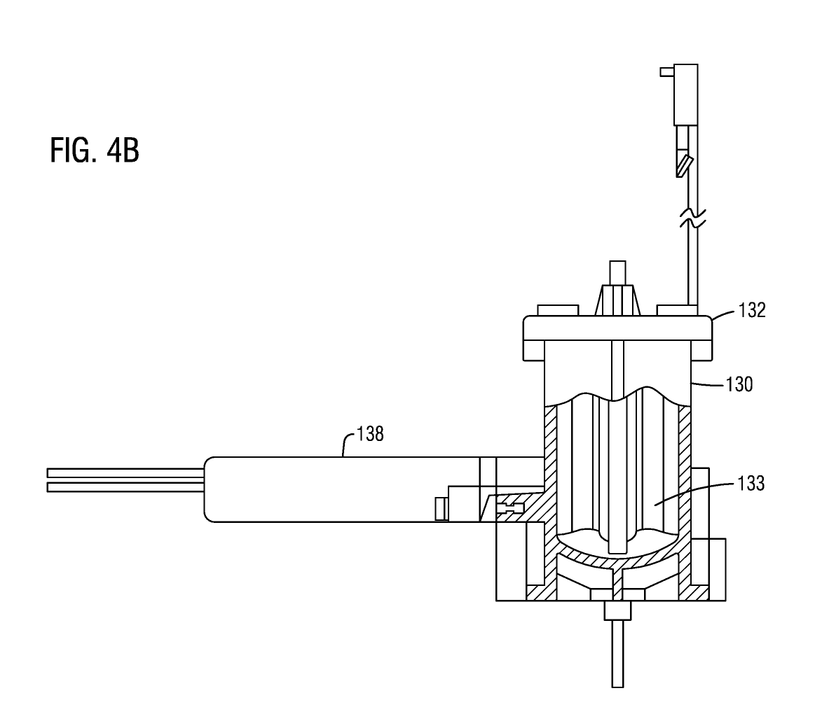

FIG. 4A shows an exploded view of the viscometer. The viscometer includes a main housing 130, a top 132, a reservoir 133, at least two sensors 134, 136 disposed in the reservoir 133, valve septum 138, and electrical connections 140 with the controller of the printer. FIG. 4B shows a partially cut-away view of the assembled viscometer. The volume of the reservoir may be between 0.1 L and 2 L.

The printer may include a service module, which is described in more detail in pending GB Application Ser. No. UK Patent Application No. 1510464.9, filed Jun. 15, 2015, the contents of which are incorporated by reference. As will be described in more detail below, in some embodiments, the service module 6 further includes a gas sensor 87, which may be operable to determine the presence or level of a gas (such as solvent vapor) within the cabinet 16.

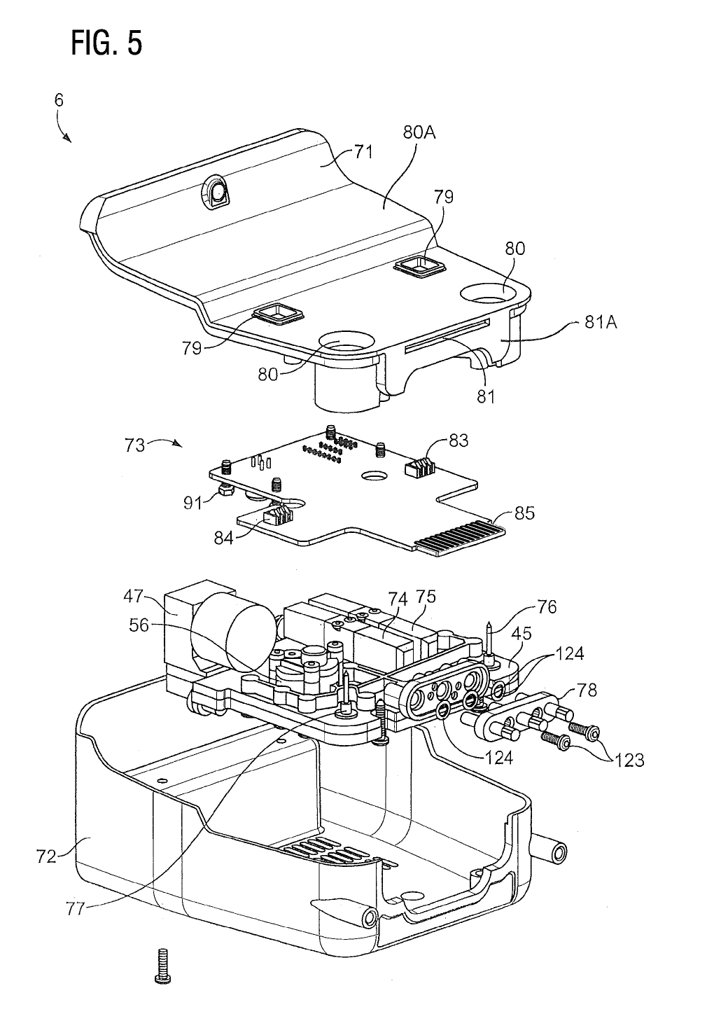

FIG. 5 shows an exploded view of an embodiment of the service module 6. The service module 6 provides an interface between the inkjet printer 1 and each of ink and solvent cartridges 8, 10, allowing fluid to flow from each of the cartridges 8, 10 to ink storage system 5, including the mixer tank 17 and providing an electrical link between the controller 4 and each of the cartridges 8, 10. Since the printer connection 11 provides for releasable engagement with an inkjet printer the service module 6 can be easily removed from the inkjet printer 1 for servicing or replacement. In general, such servicing or replacement will be performed at a different rate to that of replacement of the fluid cartridges 8, 10, or the rate of replacement of other replaceable components of the printer 1. This is advantageous because during operation of the inkjet printer 1, one or more of the plurality of conduits 46, valves 48, 49, 50, 51 and flush pump 47 may become blocked or damaged, or the gas sensor 87 may reach the end of its useful life.

Service module 6 includes a housing, which is formed from upper and lower housing portions 71, 72. Housed within the housing, the service module 6 includes a printed circuit board 73, the body 45, the pump 47, the pressure relief valve 56, two valve bodies 74, 75, two septum needle assemblies 76, 77 and a fluid pin block 78.

The upper portion 71 of the housing provides an ink cartridge receiving portion and a solvent cartridge receiving portion. The upper portion 71 of the housing includes two generally square apertures 79 and two generally circular apertures 80. A front surface of the upper portion 71 of housing is provided with a slit 81.

The two septum needle assemblies 76, 77 each provide a fluid connector for engaging an outlet of a fluid cartridge to allow fluid to flow from the engaged cartridge to one of the plurality of fluid conduits 46 of the body 45 (see FIG. 2).

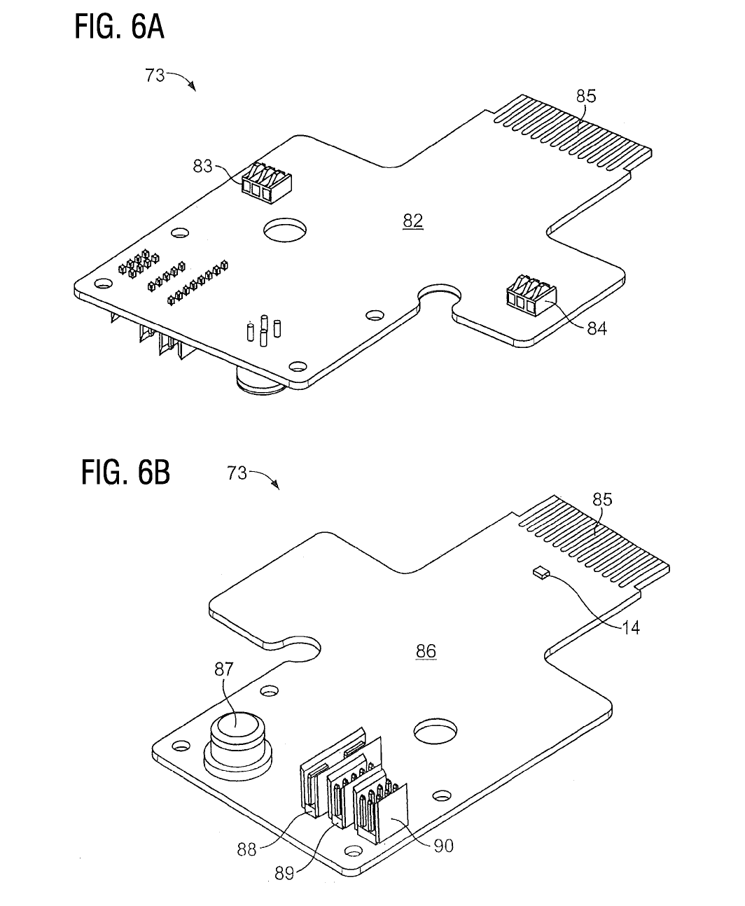

As shown more clearly in FIGS. 5-6, printed circuit board 73 is provided on an upper side 82 thereof with two connectors 83, 84. The two connectors 83, 84 may be of known type having one or more spring biased electrical contacts. In one embodiment, the two connectors 83, 84 may include a standard three-way battery connector. The printed circuit board 73 is further provided with a card edge connector 85 provided along one edge of the printed circuit board 73. Card edge connector 85 is of known construction and includes a plurality of conductive strips provided on the surface of the printed circuit board 73.

Printed circuit board 73 is provided on a lower side 86 thereof with electronic data storage device 14, a gas sensor 87 and three connectors 88, 89, 90. Printed circuit board 73 is provided with electrical links between the card edge connector 85 and each of: the connectors 83, 84, the electronic data storage device 14, the gas sensor 87, and the connectors 88, 89, 90. In use, this allows signals to be sent between each of these and the controller 4 via card edge connector 85.

The gas sensor 87 may be operable to determine the presence or level of a gas (such as solvent vapor) within the housing 71, 73. The gas sensor 87 may be operable to send a signal indicative of the presence or level of a gas to controller 4. Such a signal may be sent continuously, intermittently or upon request. The presence of solvent vapor in the vicinity of the inkjet printer 1 may indicate a fault (for example a leak, or a failure of an air circulation system the purpose of which is to remove solvent vapor from interior spaces of the printer). As such, when a signal indicating the presence of solvent vapor, or a greater than expected concentration of solvent vapor, is received by the controller 4 the controller 4 may output an alarm signal in the form of an audible or visible alarm signal. Therefore, it is desirable to provide a gas sensor in the vicinity of an inkjet printer, for example within a cabinet of the printer. Gas sensors can become “poisoned” over time and therefore generally have a finite service lifetime, requiring replacement thereafter. It is particularly advantageous to provide a gas sensor 87 in the service module 6 since service module is easily replaceable (by virtue of its printer connection 11). The gas sensor 87 may be a catalytic gas sensor. Suitable gas sensors include the NAP-50A catalytic gas sensor and the NAP-56A catalytic gas sensor, both available from Nemoto (Europe) B.V. of the Netherlands.

In use, the service module 6 may be disposed in a lower portion of the cabinet 16 of inkjet printer 1. This is particularly advantageous for detection of solvent vapor within the cabinet 16 because solvent vapor is denser than air and will therefore tend to collect in the lower portion of the cabinet 16.

The present printer 1 has an unprecedented number of sensors provided in various components for measuring various parameters of the printer. For example, there may be various sensors for various components in the print head, ink system, consumables, and electronics. As an example, the print head sensors can includes a nozzle sensor, a phase sensor, a deflection electrode sensor, and a gutter sensor. Ink system sensors can include an ink pump sensor, an ink reservoir sensor, and a viscometer sensor. Consumable sensors can include an ink cartridge sensor and a solvent cartridge sensor. These sensors provide information on parameters related to the corresponding component. The combined information from the various sensors from various components provide voluminous amounts of information on the status of various systems in the printer to allow a user (which may be the operator of the printer or a remote service provider) to diagnose and predict potential issues, such as faults, warning, or failures, with the printer.

Examples of print head parameters are shown in Table 1 below. The print head may include a nozzle with sensed parameters such as the modulation voltage, modulation current, frequency, temperature, jet velocity, actual velocity, target pressure, temperature-compensated target pressure, and actual pressure; phase sensor parameters including selected phase, phase rate of change, profile, and phase threshold; EHT parameters such as voltage, current, trip value, and % of trip; gutter parameters such as build up, time since last clean, warning level setting, and presence of ink in gutter. An optical gutter sensor is disclosed in pending PCT application no. PCT/US2015/034161, the contents of which are incorporated by reference. Further sense parameters include accelerometer sensors such as orientation and presence of shock or vibration; print head heater parameters such as set temperature, actual temperature, and drive; print head cover parameters such as status (on or off) and time since last removed; the status of various print head valves (open, closed, and time open or closed); nozzle parameters such as nozzle size, target velocity, serial number, manufacture date, drop frequency, print count, run hours, and drops deflected. The print head may include an accelerometer for determining the orientation of the print head. Such accelerometers are known in the art and are commonly provided, for example, in mobile phones.

TABLE 1
Print head sensors

| Assembly | Parameter |
|---|---|
| Nozzle | Modulation Voltage |
| | Modulation Current |
| | Frequency |
| | Temperature |
| | Jet Velocity |
| | Pressure |
| Phase sensor | Selected phase |
| | Phase Rate of Change |
| | Profile |
| | # Holes in phase profile |
| | Threshold |
| EHT | Voltage |
| | Current |
| | Trip value |
| | % of Trip |
| Gutter | Build up |
| | Time since last clean |
| | Warning level setting |
| | Ink in gutter |
| Accelerometer | Orientation |
| | Shock/vibration |
| Air purge | Humidity |
| Heater | Set Temp |
| | Actual temp |
| | Drive |
| Cover | Status |
| | Time since last removed |
| Valves | Feed (VF) |
| | VF open time |
| | Flush (VL) |
| | VL open time |
| | Gutter (VG) |
| | VG open time |
| | Purge (VP) |
| | VP open time |
| Print Module | Nozzle size |
| | Target velocity |
| | PM serial number |
| | Manufacture date |
| | Run hours |
| | Drops deflected |
| | Last chance filter pressure drop |

Examples of ink system sensed parameters are shown in Table 2 below. Sensed parameters in the ink system include ink pump parameters such as pressure, speed, current, and pump run hours; ink reservoir parameters such as ink type, ink expiry date, fluid level (ml and/or %), print hours remaining, and ink tank temperature; make up reservoir parameters such as make up type, expiry date, makeup vacuum, fluid level (ml and/or %), print hours remaining, and makeup tank temp; viscometer parameters such as target time to empty, actual time to empty, ink density, ink viscosity, ink temperature, and fill time; condenser parameters such as status (on or off), temperature, and vent valve (on or off); air pump speed; fume level of the gas sensor; filter/damper module parameters such as ink filter pressure drop, serial number, manufacture date, run hours, and replacement date; service module parameters such as flush pump speed, flush pump current, serial number, manufacture date, run hours, replacement date, and information for various service module valves (open, closed, and time open or closed).

TABLE 2
ink system sensors

| Assembly | Parameter |
|---|---|
| Ink pump | Pressure |
| | Speed |
| | Drive |
| | Run hours |
| | Current |
| Pressure Transducer | Zero offset |
| Ink Reservoir | Ink type |
| | Expiry date |
| | Fluid level |
| | Ink consumption rate |
| | Hours remaining |
| | Ink tank temp |
| | Ink conductivity |
| Make Up Reservoir | MU type |
| | Expiry Date |
| | Fluid level |
| | Fluid level |
| | MU consumption rate |
| | Hrs remaining |
| Viscometer | Target time to empty |
| | Actual time to empty |
| | Density |
| | Viscosity @ nozzle temp |
| | Fill time |
| | VMS valve (Vv) |
| Condenser | Status |
| | Temperature |
| | Vent Valve (VS) |
| | Re-circulate |
| Air Pump | Air pump speed |
| Leak detector | Fume level |
| Cabinet Fan | Speed |
| Filter/Damper | Ink Filter pressure drop |
| Module | Serial number |
| | Manufacture date |
| | Run hours |
| | Replacement date |
| Service Module | Flush pump speed |
| | Flush pump current |
| | Serial number |
| | Manufacture date |
| | Run hours |
| | Replacement date |
| | Ink add (Vi) |
| | Vi open time |
| | MU add (VM) |
| | VM open time |
| | Transfer (VT) |
| | VT open time |
| | MU Reservoir (VR) |
| | VR open time |

Examples of consumable system sensed parameters are shown in Table 3 below. Sensed parameters in the consumable system include ink cartridge parameters such as ink type, recommended make up type, serial number, manufacture date, expiry date, cartridge size, fluid level, run elapsed time, time to cartridge replacement, number of cartridge insertions, viscosity coefficient(s), fluid density, modulation algorithm numbers, and cold start algorithm numbers; make up cartridge parameters such as makeup type, serial number, manufacture date, expiry date, cartridge size, fluid level, run elapsed time, time to cartridge replacement, and number of insertions.

TABLE 3
Consumable sensors

| Assembly | Parameter |
|---|---|
| Ink Cartridge | Ink type |
| | Recommended Makeup |
| | Serial number |
| | Manufacture date |
| | Expiry date |
| | Date this cartridge first fitted |
| | Cartridge size |
| | Fluid level |
| | Time to cartridge replacement |
| | Number of insertions |
| | Visc coefficient 1 |
| | Visc coefficient 2 |
| | Visc coefficient 3 |
| | Density |
| | Modulation Algorithm |
| | Cold start Algorithm |
| Make Up Cartridge | MU type |
| | Serial number |
| | Manufacture date |
| | Expiry date |
| | Date this cartridge first fitted |
| | Cartridge size |
| | Fluid level |
| | Time to cartridge replacement |
| | Number of insertions |
| Air Filters | Date last replaced |
| | Run hours |
| | Replacement date |
| | Blocked (ink/ambient temp differential) |

Sensed parameters in the air filter include parameters such as date last replaced, run hours, and replacement date; main control board parameters such as time and date, electronics temperature, HV voltage, HV Current, and the voltage of various other power supplies within the electronics. Other sensed parameters include humidity within a portion of the printer cabinet; ambient humidity outside the printer and the above described fume sensor.

For a network including a plurality of industrial printers, which may number in the thousands, it can be seen that there is a huge amount of data that can be obtained, including the above-mentioned sensor data, parameter data, fault and warning events, other events, and environmental data. All of this data in combination can be considered historical data. Based on this historical data, a computer system or processor can determine correlations between the data, such as between environmental conditions and fault data. For example, it may be determined that for printers in high temperature environments, pump motors are more likely to overheat and have a shorter service life. These correlations can be used to determine the action to be performed on the printer.

The sensor data can be used (potentially in combination with historical data) to predict potential failures or other faults. Examples are shown in Table 4 below. For example, if the speed of a pump is changing over time, it may indicate that the pump is wearing and will fail at a certain point. As another example, an increasing pressure drop across a filter indicates that maintenance on the filter may be required. Therefore, it is advisable to perform preventative maintenance on the filter before failure occurs. As another example, for the fume/gas sensor 87, it may be determined that if the gas content (e.g. solvent such as MEK) in the printer exceeds a predetermined value, that indicates that, more likely than not, there is a solvent leak in the printer and maintenance needs to be performed. As another example, if the accelerometer indicates atypical vibrations or shock, it may indicate that a user dropped or otherwise abused the print head, or that the print head is positioned in such a manner that vibrations or the like can adversely affect the print quality. It can be seen that a variety of such correlations may be deduced from sensor data and used to provide a variety of warnings or actions to be taken.

TABLE 4
Example predictive faults for an industrial printer.

| Sensor Data | Potential Fault |
|---|---|
| Gutter build up % | EHT trip or clipping code |
| EHT % of trip value | Miscalibration, very dirty print head |
| Phase threshold | Ink charging problems |
| Phase rate of change | Break up instability |
| Humidity | H2O contamination of ink, lack |
| | of dry air kit |
| Ink conductivity | Ink condition |
| Ink temperature | Reduce cooling air flow |
| Viscosity | Ink condition |
| Viscometer fill time | Restrictor blocking |
| Last chance filter | Filter maintenance required |
| pressure drop | |
| Ink filter pressure drop | Filter maintenance required |
| Pump speed | Pump wear |
| Pump Drive % | Pump wear |
| Electronics temp vs | Air filter blockage |
| ambient temp | |
| Head temperature vs | Head heater failure |
| ambient temp | |
| Flush pump speed | Flush Pump wear |
| Air pump speed | Air pump wear |
| Head vibration/shock | poor print quality, low uptime, |
| | customer abuse |
| Valve open time (v1-v8) | slow/lazy valves/sticking valves |
| Fume level | Vapor leak |
| PH cover time since last | Low uptime, Lack of print head |
| removed | maintenance |
| Number of missed prints | Photocell obscured or damaged |

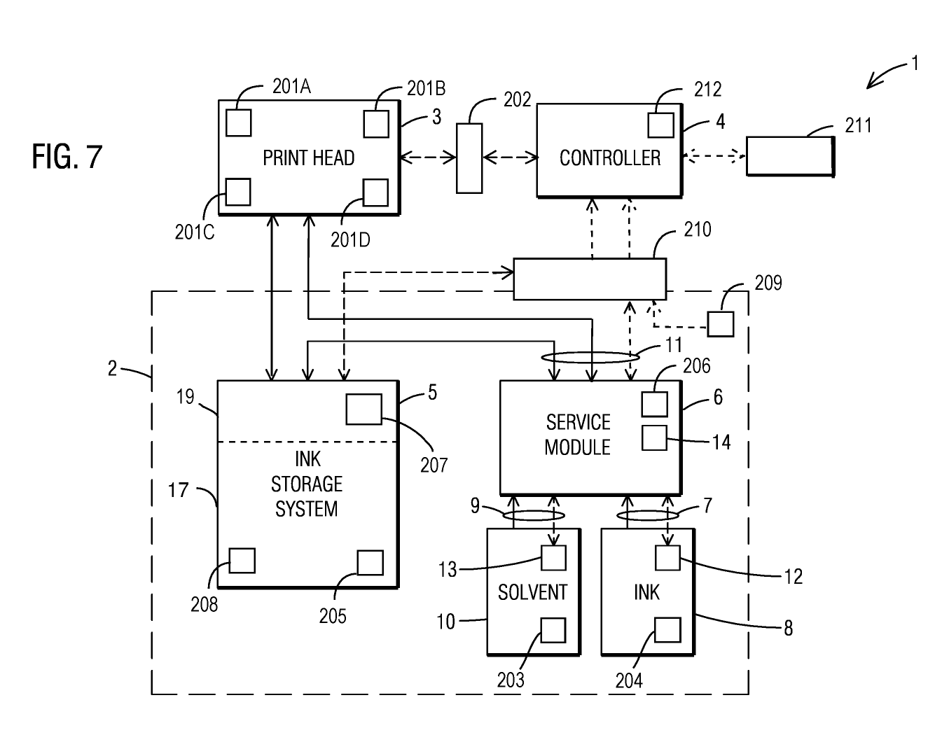

In reference to FIG. 7, the continuous inkjet printer 1 is shown including a condition monitoring system including a plurality of sensors and a plurality of controllers (also referred to as control boards) for monitoring operating conditions or parameters of the printer 1. In this embodiment, the print head 1 or condition monitoring system thereof, may include two local controllers including a print head controller 202 and ink module controller 210, and addition to the main controller 4.

In one aspect, the condition monitoring system includes a plurality of print head sensors 201A, 201B, 201C, 201D. While there are four sensors shown, this is provided by way of example as the print head 3 may include more or fewer sensors.

Sensor 201A may be an accelerometer that detects and/or monitors an orientation of the print head 3. For example, depending on the particular application of a production line print job, the print head 3 may be oriented in a vertical position above or below a production line, or in a horizontal position lateral offset relative to a production line. In each instance the accelerometer may generate signals that may be indicative of vertical or horizontal position of the print head 3 or nozzle 32 (FIG. 2), relative to a point of origin therefore to determine if the position of the print head 1 is maintained according to preset limits.

In addition or alternatively, the print head 1 may be incorporated in a printing operation in which the print head 1 moves relative to stationary products for printing on the products. The accelerometer 201A may be configured to detect an acceleration and/or deceleration of the print head 1; and/or the accelerometer 201A may be configured to detect shock or vibrations of the print head 1, for example when it is stopped before changing direction of movement. An example of an accelerometer for use as described above is model MMA 3451Q, which is a three-axis digital accelerometer manufactured and sold by Freescale Semiconductor.

Sensor 201B, 201C, 201D may include, for example, a temperature sensor, a gutter build-up sensor as described above or a phase sensor or other types of sensors that detect operating parameters of the print head 3.

Again in reference to FIG. 7, print head controller 202 is provided in electrical communication with the sensors 201A, 201B, 201C, 201D. In an embodiment, the print head controller 202 is supported within a chassis or housing of the print head 3 and is preferably configured or programmed to translate signals received from sensor 201A, 201B, 201C, 201D into serial data packages for transmission to the main controller 4 via a serial communication line housed in the umbilical conduit 15 (FIG. 1). To the extent, that signals from the sensor 201A, 201B, 201C, 201D generate analog signals indicative of operating parameters associated with the print head 3, the controller 202 may be configured to convert the analog signals to digital data, which are translated to serial data packages.

In addition, the ink supply system 2 may include a plurality of ink supply sensors 203, 204 205, 206, 207, 208, 209. While there are five sensors shown, this is provided by way of example because the ink supply system 2 may include more or fewer sensors. Sensors 203, 204, 205 may be fluid level sensors, as known to those skilled in the art, to detect fluid levels within the solvent cartridge 10, ink cartridge 8 and mixer unit 17, respectively. Sensor 206 may be the above referenced gas sensor for detecting, for example, gases such as solvent vapor. Detected solvent vapor exceeding an upper threshold concentration may be indicative of a vapor leak in a fluid line, tank or cartridge.

Sensor 207 may be a viscometer disposed within the ink storage system 5 or is in fluid communication with the ink 18 of the mixer tank 17 to detect and monitor a viscosity of the ink reservoir. The sensor 207 may, for example, may be configured to measure the rate at which ink may drain from a reservoir of the sensor 207 as described above with respect to viscometer 52.

Sensor 208 may be the above described ink quality sensor system 100, in reference to FIG. 3, to monitor the resistivity of the ink and correspondingly the quality of the ink 18. Sensor 209 may be a humidity sensor mounted within in the cabinet in which components of the ink supply system 2 are maintained. In an embodiment, the cabinet (not shown) may include a vent so that sensor 209 is in fluid communication with ambient air relative to the cabinet to detect an ambient humidity under which the printer 1 is operating. The sensor 209 may also be configured to generate a digital temperature output. An example of such a sensor is the HTU21D(F) sensor model manufactured and sold by Measurement Specialties™, which produces digital outputs for humidity and temperature.

Again in reference to FIG. 7, in an embodiment, the printer 1 and condition monitoring system may include an ink module controller 210 that is in signal communication with the above-referenced sensors 203, 204, 205, 206, 207, 208, 209 of the ink supply system 2. In addition, the ink module controller 210 is in signal communication with the main controller 4 to transmit data, in response to signals received from the ink supply sensors, to the controller 4.

The ink module controller 210 is configured to package signals received from sensors 203-209 into serial data packages and transmit data indicative of the detected parameters To the extent, that signals from the sensor 203-209 generate analog signals indicative of operating parameters associated with the print head 3, the controller 202 may be configured to convert the analog signals to digital data, which are translated to serial data packages for transmission to the main controller 4.

The main controller 4 is configured or programmed to, at least, compare operating parameter data received from the print head controller 202 and ink module controller 210, which data is representative of detected operating conditions. Accordingly, the main controller 4 may include a memory device 212, which may be a flash memory in which programmable instructions are stored and parameter thresholds are stored to monitor a condition or conditions of the printer 1.

The term “controller” or “control board” as used herein means the electronic circuitry that carries out executable instructions of a computer program according to arithmetic, logic, control and input/output (I/O) operations as specified by the instructions. For example, the main controller 4 may be programmed to perform as a proportional-integral-derivative (PID) controller to compare a detected acceleration or deceleration of the print head 3, and transmit signals in response to a detected pressure differential above or below the thresholds. In the event the detected upper and lower acceleration/deceleration thresholds alarms or warnings may be activated by the controller and/or displayed on the touchscreen of user interface 211.

The output generated by the main controller 4 and displaced on the user interface 211, may include for example an alphanumeric indication of a current operating parameter of printer component, an alphanumeric indication of a remaining useful life of a printer component, an alphanumeric instruction regarding remedial action to take regarding a printer component, an alphanumeric or audible warning regarding imminent failure of a component and other indications as necessary to monitor the condition of printer 1 and its components.

The described and illustrated embodiments are to be considered as illustrative and not restrictive in character, it being understood that only the preferred embodiments have been shown and described and that all changes and modifications that come within the scope of the inventions as defined in the claims are desired to be protected. It should be understood that, while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

What is claimed is:

1. An ink quality system for an inkjet printer, comprising:
an ink reservoir comprising a volume of ink;
a first sensor disposed in the ink reservoir, wherein at least a portion of the first sensor is in contact with the volume of ink;
a second sensor disposed in the ink reservoir, wherein at least a portion of the second sensor is in contact with the volume of ink;
electronic circuitry in electrical communication with the first sensor and the second sensor and configured to measure a quality of the ink by measuring the resistance of the ink between the first sensor and the second sensor.

2. The system of claim 1 wherein the electronic circuitry comprises:
an element for providing an electrical signal to one of the first and second sensors;
an amplifier for amplifying an electrical signal from the other of the first and second sensors; and
a rectifier in electrical communication with the output of the amplifier.

3. The system of claim 2 wherein the electronic circuitry further comprises a second amplifier for amplifying the output of the rectifier and an analog-to-digital converter for providing a digital signal.

4. The system of claim 1 wherein the first sensor and second sensor also function as fluid level sensors for the ink reservoir.

5. The system of claim 1 wherein the first sensor and second sensor are disposed in a viscometer of the inkjet printer.

6. The system of claim 1 wherein the first sensor and second sensor are disposed in a mixing tank of the inkjet printer.

7. The system of claim 1 wherein the printer is a continuous inkjet printer.

8. The system of claim 1 wherein the ink reservoir has a volume of between 0.1 L and 2 L.

9. A method of measuring quality of ink in an inkjet printer, comprising:
providing a volume of ink in the inkjet printer;
providing a first sensor and a second sensor in electrical contact with the ink;
providing an electrical signal to the first sensor;
processing an output of the second sensor to measure resistance of the ink to determine a resistivity of the ink.

10. The system of claim 9 further comprising amplifying an electrical signal from the second sensor using an amplifier; and rectifying an output of the amplifier.

11. The system of claim 10 further comprising amplifying an output of the rectifier and using a digital converter to provide a digital signal from the amplified signal.

12. The method of claim 9 wherein if the resistivity of the ink is greater than a predetermined value, an action is taken.

13. The method of claim 12 wherein the predetermined value of the resistivity is 2500 Ohms·cm.

14. The method of claim 12 wherein the predetermined value of the resistivity is 3000 Ohms·cm.

15. The method of claim 12 wherein the predetermined value depends on ink type or raster being printed.

16. The method of claim 12 wherein the action comprises issuing a warning.

17. The method of claim 12 wherein the action comprises adding ink from an ink container to the reservoir.

18. The method of claim 9 comprising measuring the resistance of the ink at least 1 time per hour.

19. A continuous inkjet printer comprising:
a print head comprising an ink drop generator having a nozzle for breaking a continuous stream of ink into individual drops, a charge electrode for selectively applying a predetermined charge to the drops, a pair of deflection plates that provide an electric field for deflecting the charged drops, and a gutter for collecting undeflected drops;
an ink supply system for supplying ink to a print head, the ink supply system comprising:
an ink reservoir;
a system pump for conveying ink from the ink reservoir to the print head;
an ink source in fluid communication with the ink reservoir; and
a solvent source in fluid communication with the ink reservoir;
a plurality of print head sensors associated with the print head to detect and monitor a plurality of different operating parameters associated with the operation of the print head and each print head sensor is configured to generate electrical signals indicative of a monitored print head operating parameter detected by a respective print head sensor;
a plurality of ink supply sensors associated with the ink supply system and configured to detect and monitor a plurality of different operating parameters associated with the operation of the ink supply system, and each ink supply sensor is configured to generate electrical signals indicative of a monitored operating parameter associated with a respective ink supply system sensor,
a print head controller in electrical signal communication with each print head sensor, and the print controller is configured to generate data representative of the respective monitored operating parameter of the print head;
an ink module controller in electrical signal communication with each ink supply sensor, and the ink module controller is configured to generate data representative of each respective monitored operating parameter of the ink supply system;
a main control board in electrical signal communication with the print head controller and the ink module controller, wherein the main controller includes stored programmable instructions to generate outputs in response to data received from the print head controller and the ink supply controller and each output is associated with a monitored parameter of the print head or ink supply system.

20. The printer of claim 19, wherein the sensors are configured to provide a measurement of the resistivity of ink to determine ink quality and to provide a measurement of ink viscosity.

21. The printer of claim 19 wherein one of the print head sensors comprises an accelerometer.

22. The printer of claim 19 wherein one of the ink supply sensors comprises a gas sensor.

23. The printer of claim 19 wherein one of the ink supply sensors or one of the print head sensors comprises a humidity sensor.
